(19) United States
(12) Patent Application Publication
(10) Pub. No.: US 2023/0396322 A1
(43) Pub. Date: Dec. 7, 2023

(54) Lunar Data Center System And Method In A Lunar Lava Tube

(71) Applicant: Arnold Castillo Magcale, San Ramon, CA (US)

(72) Inventor: Arnold Castillo Magcale, San Ramon, CA (US)

(21) Appl. No.: 17/955,535

(22) Filed: Sep. 28, 2022

Related U.S. Application Data
(60) Provisional application No. 63/350,018, filed on Jun. 7, 2022.

(51) Int. Cl. H04B 7/185

(52) U.S. Cl. CPC H04B 7/18513; H04B 7/18517; H04B 7/18515

(57) ABSTRACT

A lunar or moon-based electronic data storage and transfer system comprising a terrestrial access point, a geostationary communications satellite, and a lunar access point wherein the geostationary communications satellite is configured to enable communication between the terrestrial and lunar access points. Preferably, the terrestrial and lunar access points are caused to establish a link or communication with the geostationary communications satellite which relays the link or communication to a low-earth orbit data storage satellite for storing and retrieving information contained within the link or communication. Alternatively, the terrestrial and lunar access points are caused to establish a link or communication with the geostationary communications satellite through which data may be stored and retrieved.

### BACKGROUND

### Field of the Invention

The present invention relates generally to data centers for storage and transfer of data. More particularly, the present invention relates to a data center and data center networks for storage, transfer and communication of data on and from a plurality of lava tubes in lunar space.

### Related Art

Over the years, computers have improved in size, speed, and performance, and the amount of data that a user creates, accesses and stores has grown exponentially. Traditional backup solutions periodically copy data to local storage media such as a hard disk-drive back-up, but such solutions may be vulnerable to device failure. With high speed internet and mobile computing accessibility on the rise, the demand to remotely store and back up data has also rapidly increased. Users and organizations are increasingly storing their data and even applications on remote data servers, and accessing their data and applications remotely. Remote data storage providers must store data reliably for extended periods of time, and many users want access to their data quickly and from any location. Additionally, in some cloud computing embodiments, many users or many terminals must access the data simultaneously from multiple points around the planet or network.

Cloud computing is a network system in which computing resources such as application programs and file storage are remotely hosted and accessed over the Internet or a proprietary network. Today's cloud storage networks use wired and wireless connections to transfer and store electronic data to and retrieve electronic data from data centers located around the world. The majority of network access originates in urban areas where land and power are expensive, while most data centers are located in rural areas where land and power are cheap, introducing an additional delay and risk as the data travels thousands of miles of wire through numerous junctions and access points. The owners of wired and wireless networks charge fees for access, throttle users and services, and expose data to additional security risks. Additionally a user must be within the coverage area of a wired or wireless network to enable use of today's cloud storage networks, making access in remote or unfamiliar locations difficult, restricted, or impossible.

Terrestrial data centers require infrastructure including structures, a reliable power source, reliable high-speed communications accessibility, cooling, and physical security. Data center locations may expose users to unwanted jurisdictions or security risks, and governmental restrictions on geographical data storage location present a complicated set of rules for data access. Physical intrusion or local disaster at a data center can result in lost data, unauthorized access, and/or service interruption. A cloud storage network connected to the internet presents additional risks, as the network is inherently accessible through multiple servers and third party networks, subjecting electronic data stored therein to potential unauthorized access, hacking attempts, and electronic security breach.

In light of the above, there are definite drawbacks to modern remote data storage networks, reliance on established network systems, and connection to the internet. Accordingly, it is here recognized that a continued need exists to overcome and improve upon such shortcomings in such conventional data storage and network systems. Therefore there exists a continuing need for a new and improved remote data storage network that can be quickly, reliably, and securely accessed from anywhere in the world. Embodiments disclosed address precisely such a need.

### SUMMARY

Embodiments disclosed include a lunar or moon-based electronic data storage and transfer system. According to an embodiment, the lunar or moon-based electronic data storage and transfer system comprises a terrestrial access point, a geostationary communications satellite, and a lunar access point wherein the geostationary communications satellite is configured to enable communication between the terrestrial and lunar access points. Preferably, the terrestrial and lunar access points are caused to establish a link or communication with the geostationary communications satellite which relays the link or communication to a low-earth orbit data storage satellite for storing and retrieving information contained within the link or communication. Alternatively, the terrestrial and lunar access points are caused to establish a link or communication with the geostationary communications satellite through which data may be stored and retrieved.

Embodiments disclosed include, in a lunar or moon-based electronic data storage and transfer system, an orbital data storage satellite for storing information comprising a geostationary communications satellite access point. Additionally, the geo-stationary communications satellite access point is caused to establish a link or communication with a geo-stationary communications satellite which relays the link or communication from a terrestrial access point to a lunar access point operatively coupled to the lunar or moon-based electronic storage and transfer system for storing information contained within the link or communication. According to an embodiment, the geo-stationary communications satellite access point is caused to establish a link or communication with the geostationary communications satellite which relays the link or communication to the terrestrial access point in response to a request by the terrestrial access point for retrieval of information stored within the link or communication.

### BRIEF DESCRIPTION OF THE DRAWINGS

FIG. 1 illustrates the space-based electronic data storage and transfer system according to an embodiment.

FIG. 2 illustrates an orbital data storage satellite for storing information according to an embodiment.

FIG. 3. illustrates the system and method for autonomous operation and healing of the space-based electronic data storage and transfer system according to an embodiment.

### DETAILED DESCRIPTION

Various aspects are described in connection with an illustrative implementation of a space-based electronic data storage and transfer network system (“satellite cloud network”) disclosed herein. The various aspects are disclosed in the written specification including the drawings, and claims, and may be combined to form claims for a device, apparatus, system method of manufacture and/or use in any way, consistent with the teachings herein, without limitation

Lava Tubes

A lava tube is a tunnel under a world's surface, formed by an intense flow of molten rock during a volcanic explosion. On Earth, they're most easily spotted when they collapse, forming long furrows in the dirt. Partial collapses sometimes form chains of “skylights” that reveal hidden lava tubes that are mostly intact. Researchers have speculated that lava tubes might exist on Mars and the moon since the 1960s, but in recent years Martian and lunar orbiters have beamed home images showing how common these formations likely are, both on the Red Planet and on our moon. Now, researchers argue in a new paper published July 20 in the journal Earth-Science Reviews, it's time to explore them in earnest.

These lava tubes are truly enormous, and might offer safer habitats than the lunar or Martian surfaces.

The largest lava tubes on Earth are maximum [about] 40 meters [130 feet] of width and height. Lunar lava tubes seem to be still larger, with collapse sites 300 to 700 times the size of Earth's. Lunar lava tubes likely range from 1,600 to 3,000 feet (500 to 900 m).

The sheer scale of these extraterrestrial lava tubes is likely a result of low lunar gravity, as well as differences in how volcanoes operated on the Moon compared to Earth.

Lava tubes make appealing human habitats for a number of reasons, including protection from meteors that don't burn up as easily in the thin Martian and Lunar atmospheres. They also likely contain useful chemicals, like water ice and volatile chemicals that can be used to make fuel. A thick layer of rock overhead can also offer shielding against solar radiation.

Further, with the increase in the number of data centers on planet Earth, the corresponding increase in the carbon foot print presents serious, non-trivial environmental challenges. There is a need to take space based data storage and transfer to the next level, i.e. the Moon! Embodiments disclosed enable such an aspiration.

Embodiments disclosed include a lunar or moon-based electronic data storage and transfer system. According to an embodiment, the lunar or moon-based electronic data storage and transfer system comprises a terrestrial access point, a geostationary communications satellite, and a lunar access point wherein the geostationary communications satellite is configured to enable communication between the terrestrial and lunar access points. Preferably, the terrestrial and lunar access points are caused to establish a link or communication with the geostationary communications satellite which relays the link or communication to a low-earth orbit data storage satellite for storing information contained within the link or communication. Alternatively, the terrestrial and lunar access points are caused to establish a link or communication with the geostationary communications satellite through which data may be stored and retrieved.

According to an embodiment of the lunar or moon-based electronic data storage and transfer system, the terrestrial access point is caused to collect data from the lunar access point via the geo-stationary communications satellite and the low earth orbit data storage satellite. Preferably, the system is configured to check if the collected data matches a prior pattern. And based on the check, the system can determine an alert condition in the geo-stationary communications satellite and the low earth orbit data storage satellite. According to an additional embodiment, the system can match the determined alert condition to a historical alert condition, and based on the match, determine a corrective action. And preferably, based on the determined corrective action, the system autonomously triggers a performance of the determined corrective action.

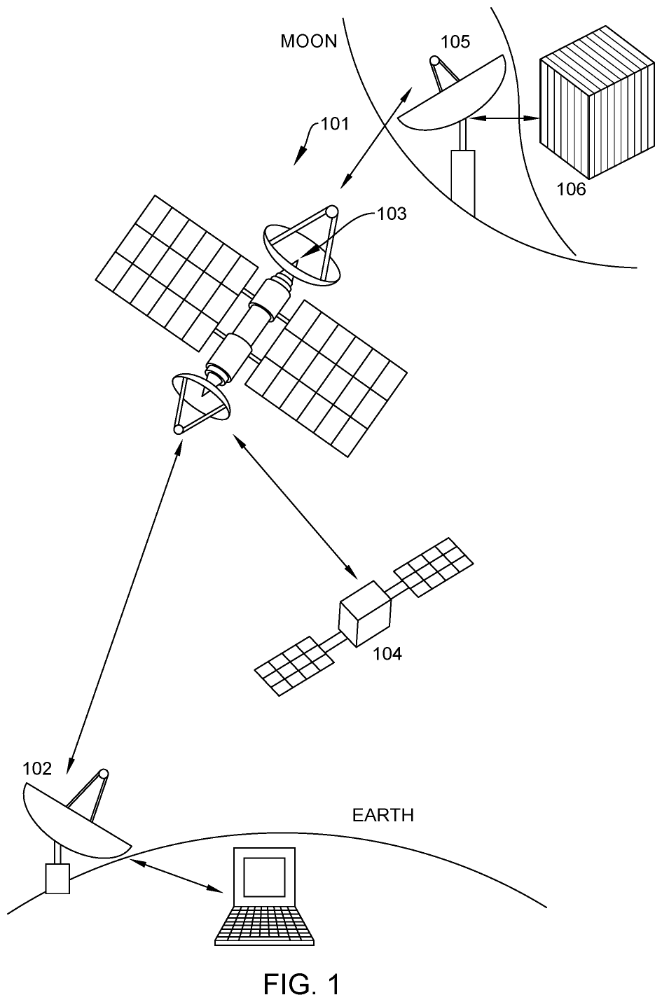

FIG. 1 illustrates the lunar or moon-based electronic data storage and transfer system according to an embodiment. The lunar or moon-based electronic data storage and transfer system 101 comprises a terrestrial access point 102, a geostationary communications satellite 103, and a lunar access point 105 operatively coupled to lunar electronic data storage and transfer device 106. Data is transferred to and from lunar or moon-based electronic data storage and transfer device 106 via terrestrial access point 102 in communication with geostationary communications satellite 103 further in communication with lunar access point 105. Additionally, geostationary communications satellite 103 can relay the link or communication to low-earth orbit data storage satellite 104 for storing information contained within the link or communication. Yet Additionally, terrestrial access point 102 links to geostationary communications satellite 103 which relays the link or communication to the low-earth orbit data storage satellite 104 requesting retrieval of information stored within the link or communication. Terrestrial access point 102 collects data through geo-stationary communications satellite 103 and low earth orbit data storage satellite 104. According to an alternate embodiment, terrestrial access point 102 links directly to lunar access point 105, and optionally, is operatively coupled to a terrestrial data center thereby expediting data communication, transmittal and retrieval.

Embodiments disclosed include, in a lunar or moon-based electronic data storage and transfer system, a lunar electronic data storage and transfer device 106 for storing information and operatively coupled to a lunar access point comprising a geostationary communications satellite access point. Additionally, the geo-stationary communications satellite access point is caused to establish a link or communication with a geo-stationary communications satellite which relays the link or communication from a terrestrial access point to the lunar data storage and transfer device via the lunar access point for storing information contained within the link or communication. According to an embodiment, the geo-stationary communications satellite access point comprised in the lunar access point is caused to establish a link or communication with the geostationary communications satellite which relays the link or communication to the terrestrial access point in response to a request by the terrestrial access point for retrieval of information stored within the link or communication.

According to an embodiment, the lunar electronic data storage and transfer device further comprises a machine cabinet, cooling equipment, and power generation apparatus. The machine cabinet comprises at least one processing unit coupled to a storage element for processing, storage and transmission of data. Preferably, the cooling equipment is disposed outside the machine cabinet, and configured to release heat generated inside the machine cabinet into space. In one embodiment, the power generation device is operatively coupled to the cooling equipment and to the machine cabinet. According to an embodiment the lunar electronic data storage and transfer device resides in a lava tube under the surface of the moon to leverage extremely low temperatures that enable expeditious heat dissipation.

According to an embodiment, the power generation device resides outside the lava tube and comprises a plurality of solar photovoltaic panels that include automated direction control capability configured to control the direction of the solar photovoltaic panels vis-à-vis the sun.

According to an embodiment of the lunar data storage and transfer device, the machine cabinet comprises a computer server comprising a hardware processing unit coupled to a memory element and further operatively coupled to the lunar access point disposed outside the lava tube. Alternatively, the machine cabinet comprises a plurality of racks containing a corresponding plurality of rack mounted computer systems.

According to an embodiment of the lunar data storage and transfer device, the cooling equipment comprises a male heat sink, a female heat sink, a radiator, a pump and a drive tube. In a preferred embodiment, the male heat sink is fastened to a low temperature wall of the lava tube, and operatively coupled to the female heat sink disposed outside the lava tube on the lunar surface in a sun facing direction. The radiator is operatively coupled to the female heat sink, however, other variations and modifications are likely, possible, and even desirable, as would be apparent to a person having ordinary skill in the art. In one embodiment, the radiator is operatively coupled to the female heat sink and to the tubular body of the male connector and the female heat sink. Additionally, driving said pump connecting said tubular body and disposed on a surface of the machine room for driving the male heat sink, the thermally conductive working medium circulating inside the female heat sink and the tubular body.

According to an embodiment of the lunar data storage and retrieval device, the cooling equipment further comprises two secondary heat sinks disposed symmetrically on two opposite side surfaces of the machine cabinet.

Yet additionally and alternatively, in an exemplary embodiment, the lunar data storage and retrieval device comprises a solar thermal power generation means disposed between the male heat sink and the female heat sink, to leverage the temperature differential between the male and female heat sink, in the Seebeck effect, and to generate a primary or secondary power to power the lunar data storage and retrieval device. In an ideal embodiment, the lunar data storage and retrieval device is a cloud computing data center.

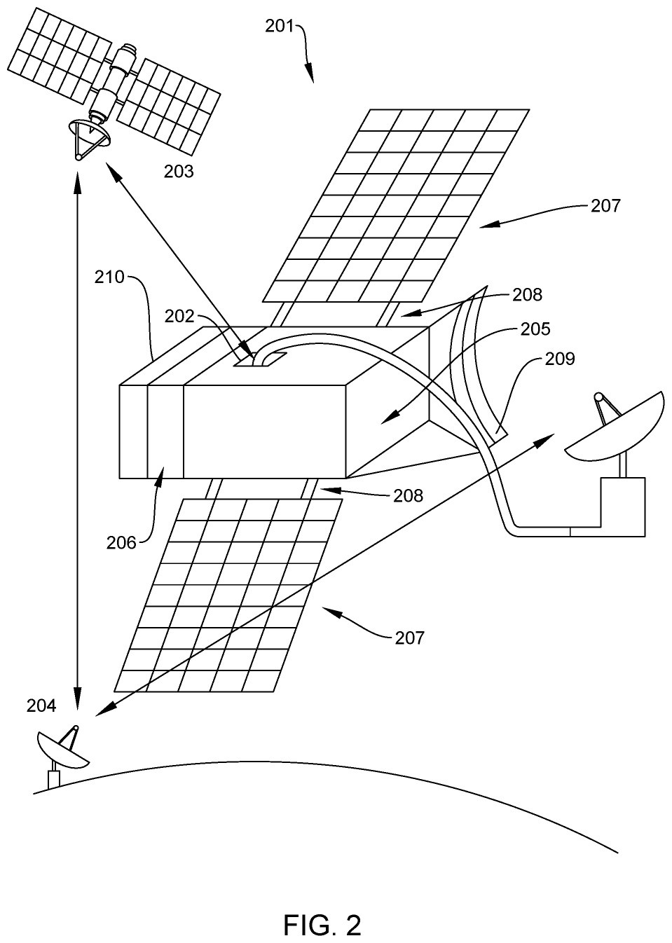

FIG. 2 illustrates a lunar data storage and retrieval device for storing information according to an embodiment. Lunar data storage and retrieval device 201 comprises geostationary communications satellite access point 202. Geo-stationary communications satellite access point 202 communicates with geo-stationary communications satellite 203 which relays the link or communication from terrestrial access point 204 to lunar data storage and retrieval device 201 via geo-stationary communications satellite access point 202 for storing information contained within the link or communication. Geo-stationary communications satellite access point 202 establishes a link with geostationary communications satellite 203 which relays the link or communication to terrestrial access point 204 in response to a request by the terrestrial access point 204 for retrieval of information stored within the link or communication. According to an alternate embodiment, lunar data storage and retrieval device 201 is operatively coupled to lunar access point 211 which enables direct communication with terrestrial access point 204. Lunar access point 211 establishes a link with terrestrial access point 204 in response to a request by the terrestrial access point 204 for retrieval of information stored within the link or communication. According to an embodiment, terrestrial access point 204 is operatively coupled to a terrestrial data center to expedite data storage, retrieval, communication and transmission to lunar data storage and retrieval device directly via lunar access point 211. Lunar data storage and retrieval device 201 further comprises machine cabinet 205, cooling equipment 206, and power generation apparatus 207. Machine cabinet 205 comprises at least one processing unit coupled to a storage element for processing, storage and transmission of data (not shown). As illustrated, cooling equipment 206 is disposed outside the machine cabinet 205, and configured to release heat generated inside the machine cabinet. In one embodiment, the power generation apparatus 207 is operatively coupled to cooling equipment 206 and to machine cabinet 205.

According to the illustrated embodiment, lunar data storage and retrieval device 201 further comprises power generation apparatus 207, and is configured to control the direction of the power generation device/apparatus vis-à-vis the sun.

According to the illustrated embodiment, machine cabinet 205 comprises a computer server comprising a hardware processing unit coupled to a memory element and further operatively coupled to a communications apparatus (not shown). Alternatively, machine cabinet 205 comprises a plurality of racks containing a corresponding plurality of rack mounted computer systems.

According to the illustrated embodiment, cooling equipment 206 comprises a male heat sink 209, a female heat sink 210, a radiator, a pump and a drive tube (not shown). In the illustrated embodiment, the male heat sink is disposed outside the lava tube in a sun-facing side of the machine cabinet, and the female heat sink is disposed inside the lava tube on an opposite surface of the machine cabinet. The radiator is operatively coupled to the female heat sink, however, other variations and modifications are likely, possible, and even desirable, as would be apparent to a person having ordinary skill in the art. In one embodiment, the radiator is operatively coupled to the female heat sink and to the tubular body of the male connector and the female heat sink. Additionally, driving said pump connecting said tubular body and disposed on a surface of the machine room for driving the male heat sink, the thermally conductive working medium circulating inside the female heat sink and the tubular body.

According to an embodiment of the lunar data storage and retrieval device, the cooling equipment further comprises two secondary heat sinks disposed symmetrically on two opposite side surfaces of the machine cabinet.

Additionally and alternatively, the lunar data storage and retrieval device is operatively coupled to solar power generation device which includes solar cell panels 207 comprised in the power generating equipment, and is disposed outside the lava tube, on the surface of the moon in a sun facing direction.

Yet additionally and alternatively, in an exemplary embodiment, the lunar data storage and retrieval device is operatively coupled to a solar thermal power generation means comprised in the male heat sink 209 and the female heat sink 210, to leverage the temperature differential inside and outside the lava tube and between the male and female heat sink, in the Seebeck effect, and to generate a primary or secondary power to power the lunar data storage and retrieval device.

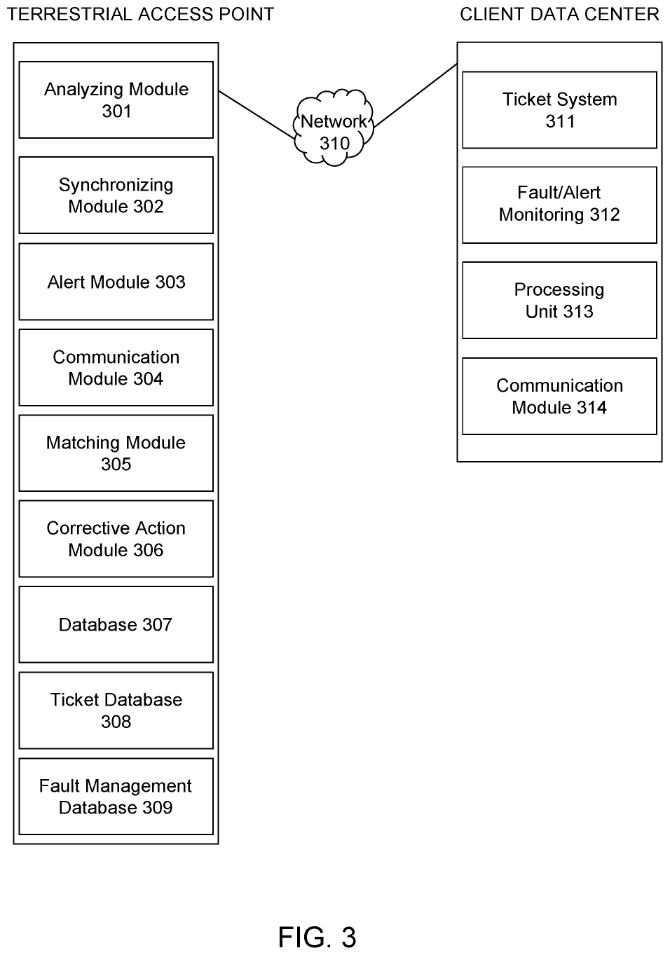

FIG. 3 illustrates the system and method for autonomous operation and healing of the lunar data storage and retrieval device according to an embodiment Terrestrial data management center server comprises analyzing module 301 to process historical data to analyze a past performance and synchronizing module 302 to synchronize collected data from a plurality of connected orbital data storage satellites with prior processed historical data. Alert module 303 is configured to detect an alert condition such as an error or a fault, in one or more of a plurality of lunar data storage and retrieval devices. And based on the detected alert condition, communication module 304 is configured to trigger the delivery of the detected alert condition to an automated network operations center (NOC). Alternatively, matching module 305 matches the determined alert condition to a historical alert condition and based on the match, corrective action module 306 determines a corrective action. Based on the match determined by matching module 305, corrective action module 306 assigns a virtual self-healing module from a plurality of virtual self-healing modules in a virtual self-healing module database 307, and then triggers the performance of the determined corrective action by the assigned virtual self-healing module. Ticket database 308 identifies and tags the alert condition, the determined solution, and the result. Ticket database 308 communicates with, updates, and is updated by a ticketing system 311 in a client data center. The terrestrial data management center server detects a ticket update in ticket database 308, the update including a record of an assignment of a single or plurality of virtual self-healing modules according to the identified alert condition. Accordingly, alert condition database in alert module 303 is also updated, the update including the assignment of the select one of the virtual self-healing modules to the alert condition. Tracking alerts, errors and faults by the ticketing system is supported by fault management database 309, wherein ticket database 308 and fault managements database 309 are configured for bi-directional communication and updates with client data center ticket system 311 client datacenter fault/alert monitoring system 312 driven by processing unit 313 and communication module 314.

Lava Tubes

Embodiments disclosed include a lunar data center deployed, constructed, and operated in lava tubes located inside the moon. Preferred embodiments of the lunar data center are constructed from materials that can withstand extreme freezing temperature and are built in a deployable modular fashion. According to an embodiment, the lunar data center is comprised in an ultra-secure disaster recovery site. Preferably, laser communications systems using Starlink and highly encrypted military grade AI based cybersecurity enable quick and secure data transfer, storage, communications, and recovery. Power can be generated via solar with a combination of battery power storage. The cooling technology used can take advantage of the water and other forms of liquid inside the lava tube or use a carbon-dioxide two phase cooling technology. According to an alternative embodiment, the existing cooling technology using ammonia as a coolant, currently deployed in the International Space Station is deployed.

Embodiments disclosed include autonomous self-healing algorithms and machine learning techniques to operate, repair and self-correct deployed servers/CPUs/GPUs in the Lunar Data Center.

Embodiments disclosed enable ultra-secure microwave dishes installed in key locations on earth to communicate with the Lunar Data Center via a low earth orbit (LEO) satellite, when and where data back-up is required. Alternate embodiments include direct communication between terrestrial access points and lunar access points without the intervention of low earth orbit (LEO) satellites. Embodiments disclosed enable military and naval superiority as data is accessible even in remote areas such as middle of the ocean from an US Navy vessel (even submarines) in the battlefield anywhere in the world.

Since various possible embodiments might be made of the above invention, and since various changes might be made in the embodiments above set forth, it is to be understood that all matter herein described or shown in the accompanying drawings is to be interpreted as illustrative and not to be considered in a limiting sense. Thus it will be understood by those skilled in the art of systems and methods of space based electronic data storage, transfer and communication, that although the preferred and alternate embodiments have been shown and described in accordance with the Patent Statutes, the invention is not limited thereto or thereby.

The figures illustrate the architecture, functionality, and operation of possible implementations of systems, methods and computer program products according to various embodiments of the present invention. It should also be noted that, in some alternative implementations, the functions noted/illustrated may occur out of the order noted in the figures. For example, two blocks shown in succession may, in fact, be executed concurrently, or the blocks may sometimes be executed in the reverse order, depending upon the functionality involved.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-accessible format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

The present invention and some of its advantages have been described in detail for some embodiments. It should be understood that although the system and process is described with reference to Lunar-based electronic data storage, transfer and communication data centers, the system and method is highly reconfigurable, and may be used in other systems as well. Portions of the embodiment may be used to support other types of data communications, transfer, storage, surveillance, and other systems. Modifications of the embodiments may be used in inter-space and Lunar communications and navigation, and the power systems may be used to capture emitted heat from heat sources and convert the captured heat to electricity to serve as an auxiliary or primary power source. It should also be understood that various changes, substitutions and alterations can be made herein without departing from the spirit and scope of the invention as defined by the appended claims. An embodiment of the invention may achieve multiple objectives, but not every embodiment falling within the scope of the attached claims will achieve every objective. Moreover, the scope of the present application is not intended to be limited to the particular embodiments of the process, machine, manufacture, composition of matter, means, methods and steps described in the specification. A person having ordinary skill in the art will readily appreciate from the disclosure of the present invention that processes, machines, manufacture, compositions of matter, means, methods, or steps, presently existing or later to be developed are equivalent to, and fall within the scope of, what is claimed. Accordingly, the appended claims are intended to include within their scope such processes, machines, manufacture, compositions of matter, means, methods, or steps.

We claim:

1. A lunar or moon-based electronic data storage and transfer system comprising:
at least one processing unit coupled to a memory element in a modular, rack mounted configuration;
a terrestrial access point;
a lunar access point operatively coupled to the at least one processing unit coupled to the memory element in the rack mounted formation; (modular fashion takes precedence over rack mounted) what they're putting on the moon is not a dc . . . it's mobile and portable . . . it
wherein the terrestrial access point is caused to establish a link or communication with the lunar access point which relays the link or communication to the processing unit coupled to the memory element in the rack mounted configuration for storage and retrieval of information stored in the memory element.
a lunar or moon-based electronic data storage and transfer system. According to an embodiment, the lunar or moon-based electronic data storage and transfer system comprises a terrestrial access point, a geostationary communications satellite, and a lunar access point wherein the geostationary communications satellite is configured to enable communication between the terrestrial and lunar access points. Preferably, the terrestrial and lunar access points are caused to establish a link or communication with the geostationary communications satellite which relays the link or communication to a low-earth orbit data storage satellite for storing and retrieving information contained within the link or communication. Alternatively, the terrestrial and lunar access points are caused to establish a link or communication with the geostationary communications satellite through which data may be stored and retrieved.
Embodiments disclosed include, in a lunar or moon-based electronic data storage and transfer system, an orbital data storage satellite for storing information comprising a geostationary communications satellite access point. Additionally, the geo-stationary communications satellite access point is caused to establish a link or communication with a geo-stationary communications satellite which relays the link or communication from a terrestrial access point to a lunar access point operatively coupled to the lunar or moon-based electronic storage and transfer system for storing information contained within the link or communication. According to an embodiment, the geo-stationary communications satellite access point is caused to establish a link or communication with the geostationary communications satellite which relays the link or communication to the terrestrial access point in response to a request by the terrestrial access point for retrieval of information stored within the link or communication.

2. The lunar or moon-based electronic data storage and transfer system of claim 1 further comprising:
a geostationary communications satellite;
wherein the geostationary communications satellite is configured to enable communication between the terrestrial and lunar access points;
wherein the terrestrial access point is caused to establish a link or communication with the geostationary communications satellite which relays the link or communication to a low-earth orbit data storage satellite for storing information contained within the link or communication; and
wherein the terrestrial access point is caused to establish a link or communication with the geostationary communications satellite which relays the link or communication to the low-earth orbit data storage satellite requesting retrieval of information stored within the link or communication.

3. The lunar or moon-based electronic data storage and transfer system of claims 1 and 2 wherein the terrestrial access point is caused to:
collect data from the lunar access point, the geo-stationary communications satellite and the low earth orbit data storage satellite;
check if the collected data matches a prior pattern;
based on the check, determine an alert condition in lunar access point and the processing unit coupled to the memory element in the rack mounted formation, the geo-stationary communications satellite and the low earth orbit data storage satellite;
match the determined alert condition to a historical alert condition;
based on the match, determine a corrective action; and
based on the determined corrective action, trigger a performance of the determined corrective action.

4. In a lunar or moon-based electronic data storage and transfer system, a data storage apparatus for storing information comprising:
at least one processing unit coupled to a memory element in a modular rack mounted configuration;
a lunar access point coupled to the at least one processing unit coupled to the memory element in the modular rack mounted configuration;
wherein the lunar access point is caused to establish a link or communication with at least one of:
a geo-stationary communications satellite which relays the link or communication from a terrestrial access point to the lunar access point for storing information contained within the link or communication in the memory element of the rack mounted configuration, and the terrestrial access point which relays the link or communication to the lunar access point for storing information contained in the link or communication in the memory element of the rack mounted configuration; and wherein the lunar access point is caused to establish a link or communication with the geostationary communications satellite which relays the link or communication to the terrestrial access point in response to a request by the terrestrial access point for retrieval of information stored within the link or communication.

5. The lunar or moon-based electronic data storage and transfer system of claim 4 further comprising:
a machine cabinet, cooling equipment, and power generation apparatus;
wherein the machine cabinet comprises at least one processing unit coupled to a storage element for processing, storage and transmission of data; and
the cooling equipment is disposed outside the machine cabinet, and configured to release heat generated inside the machine cabinet into space; and wherein the power generation device is operatively coupled to the cooling equipment and to the machine cabinet.

6. The lunar or moon-based electronic data storage and transfer system of claim 4, further comprising:
a control device coupled to the power generation device, and configured to control the direction of the power generation device vis-à-vis the sun.

7. The lunar or moon-based electronic data storage and transfer system of claim 5, wherein the machine cabinet comprises:
a computer server comprising a hardware processing unit coupled to a memory element and further operatively coupled to the lunar access point.

8. The lunar or moon-based electronic data storage and transfer system of claim 5, wherein the machine cabinet comprises a plurality of modular racks containing a corresponding plurality of modular rack mounted computer systems.

9. The lunar or moon-based electronic data storage and transfer system of claim 5, wherein the cooling equipment comprises:
a male heat sink, a female heat sink, a radiator, a pump and a drive tube;
the male heat sink is disposed away from the rack configuration in a sun-facing side; the female heat sink disposed on an opposite surface of the machine cabinet;
wherein the radiator is operatively coupled to the female heat sink;
the tubular body of the male connector and the female heat sink driving said pump connecting said tubular body and disposed on a surface of the machine room for driving the male heat sink, the thermally conductive working medium circulating inside the female heat sink and the tubular body.

10. The lunar or moon-based electronic data storage and transfer system of claim 5, wherein said cooling equipment further comprises:
two secondary heat sinks; the two secondary heat sinks disposed symmetrically on two opposite side surfaces of the machine cabinet.

11. The lunar or moon-based electronic data storage and transfer system of claim 5, characterized in that the solar power generation device includes a solar cell panel disposed away from the rack mounted configuration.

12. The lunar or moon-based electronic data storage and transfer system of claim 5, wherein said apparatus further comprises a solar thermal power generation means disposed between the male heat sink and the female heat sink.

13. The lunar or moon-based electronic data storage and transfer system of claim 1, wherein the lunar or moon-based electronic data storage system comprises a modular data center in a rack mounted configuration.

14. The lunar or moon-based electronic data storage and transfer system according to claims 1 to 10, wherein the lunar or moon-based electronic data storage and transfer system is housed inside a lava tube or lava tunnel beneath the lunar surface on the moon, protected from lunar atmospheric debris.

15. The lunar or moon-based electronic data storage and transfer system of claim 5 wherein the cooling equipment further comprises a plurality of heat-exchangers and cooling media such as CO2, Ammonia and radiation from space.

16. The lunar or moon-based electronic data storage and transfer system of 3, further comprising Artificial Intelligence based predictive analytics, to run, maintain and repair the data center.

17. The lunar or moon-based electronic data storage and transfer system of claim 5 wherein the machine cabinet is constructed from materials comprising all types of metals, alloys, carbon-fiber, kevlar, wood, HDPE, or fiberglass.
